(19) United States
(12) Patent Application Publication
(10) Pub. No.: US 2004/0094690 A1
(43) Pub. Date: May 20, 2004

(54) Method of stable focus control for an optical drive

(76) Inventors: Sun Yu-Hung, Taipei (TW); Chang Chih-Hao, Taipei (TW); Sen-Ming Chuang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/430,951

(22) Filed: May 5, 2003

(30) Foreign Application Priority Data
Nov. 18, 2002 (TW) 91132978

(51) Int. Cl. G02B 7/04

(52) U.S. Cl. 250/201.5

(57) ABSTRACT

A method of stable focus control for an optical drive is disclosed. When the signal processing circuit of the optical drive detects a focus drop, the rotation speed of the spindle motor is detected and compared to a predetermined rotation speed. When the rotation speed of the spindle motor is faster than the predetermined rotation speed, the spindle motor brakes to re-focus, and the focus servo mechanism is reset from open-loop control to closed-loop control. Thus, the focus point is locked on the optical disk.

### BACKGROUND OF THE INVENTION

1. Field of the Invention

The present invention relates to a method of stable focus control for an optical drive, and particularly to a method of stabilizing the re-focusing process for an optical drive with significant focus vibration when the optical drive is operated at a high rotation speed.

2. Description of the Related Art

A focus system for the optical pickup module of an optical drive is illustrated in FIG. 1. In the focus system, a user inputs a command via the interface 21, and the interface 21 sends the command to the signal processing circuit (SPC) 22. The SPC 22 transfers the command to a control signal and sends the control signal to the control circuit (CC) 23, so that the control circuit 23 drives the focus servo mechanism (FSVR) 24 and the spindle controller (SSVR) 25 to perform focusing on the optical disk 18 in the optical drive.

The optical pickup module 10 has a laser diode 11, a beam splitter 12, an object lens 13, a focus actuator 14, and a light detector 15. The laser diode 11 directs a laser beam toward the beam splitter 12, and the laser beam through the beam splitter 12 and the object lens 13 is focused to a focus point. The position of the focus point is controlled by the object lens 13, which is moved by the focus actuator. The focus servo mechanism 24 controls the focus point of the optical pickup module 10 that moves perpendicularly to the surface of the optical disk 18 rotated by the spindle motor 16 so as to lock the focus point on the surface of the optical disk 18. Thus, the surface of the optical disk 18 reflects the laser beam back to the object lens 13 and the beam splitter 12, and the beam splitter 12 guides the reflected laser beam toward the light detector 15. The light detector 15 receives the reflected laser beam as an optical signal, and sends the optical signal to the SPC 22 to obtain electrical signals, such as a focus error (FE) signal and a radio frequency (RF) signal.

Alternatively, the spindle controller 25 controls the rotation speed of the spindle motor 16. The rotation speed of the spindle motor 16 corresponds to the position of the focus point relative to the optical disk 18, so that the optical pickup module 10 correctly retrieves data from the optical disk 18.

There are various methods applied in the optical pickup module 10 to obtain the focus point, such as astigmatism, knife edge, spot size, or critical angle. With any of the methods, the FE signal is obtained with a shape similar to the shape of the letter “S” as shown in FIG. 2, which is referred to as “S-curve.” When the FE signal reaches zero, which is shown at a point O in FIG. 2, the focus is accurate. The point O is defined as a focus zero-crossing (FZC) point, and the RF signal at the (FZC) point O reaches a maximum value.

FIG. 2 shows that the FE signal reaches a maximum value and a minimum value on each side of the FZC point O. The S-curve of the FE signal between the maximum value point and the minimum value point has an approximate linear portion. Consequently, accurate focus control can be obtained by controlling the FE signal in the range of the approximate linear portion.

It is possible that the focus point is positioned so that the FE signal falls beyond the approximate linear portion on the S-curve. In this case, the focus servo mechanism 24 operates under open-loop control to move the FE signal within the range of the approximate linear portion. The approximate linear portion is obtained by a threshold of the RF signal as shown in FIG. 2. When the RF signal reaches the threshold, the FE signal falls within the range of the approximate linear portion, and the focus servo mechanism 24 can be reset to operate under closed-loop linear control.

FIG. 3 shows a block diagram of the focus servo mechanism under open-loop control. In FIG. 3, the digital/analog signal processing IC (D/A IC) 31 receive a control command CCMD and outputs a control signal CS. The control signal CS is amplified by the compensator 32 and transformed by the driver (DVR) 33 to obtain a focus driving signal FDS. The focus actuator (FA) 34 controls the object lens 13 to move according to the focus driving signal FDS, and the FE signal is obtained by the light detector (LDTR) 35 and the RF amplifier (AMP) 36. Thus, the distance between the focus point and the surface of the optical disk 18 is obtained by the FE signal.

FIG. 4 shows a block diagram of the focus servo mechanism under closed-loop control. The difference between the closed-loop control block diagram in FIG. 4 and the open-loop control block diagram in FIG. 3 is the feedback of the FE signal to the control command end. Further, the compensator 32 and the driver 33 in FIG. 4 can be designed so that the focus actuator 34 controls the object lens 13 to tune according to the FE signal. Thus, the FE signal falls approximately at the FZC point O on the S-curve; that is, the focus point falls on the surface of the optical disk 18.

FIG. 5 is a diagram showing the focusing process of the focus servo mechanism. When the focus servo mechanism is under open-loop control as shown in FIG. 3, the focus driving signal FDS is input to the focus actuator 34 in the form of a triangular wave pulse, and the focus actuator 34 controls the object lens to move and perform an S-curve search process. At the time T1, a triangular wave pulse is input. When a focus zero-crossing point is detected by the S-curve search process at the time T2, the focus servo mechanism is reset to operate under closed-loop linear control.

However, it is well known that focus vibration increases when the spindle motor 16 in FIG. 1 of the optical drive is operated with increased rotational speed. Specifically, the optical disk 18 may be irregularly manufactured or printed in the disk printing process and may have a slightly inclined or curved surface, or be inaccurately positioned in the disk holding device 17 of the optical drive, so that the disk wobbles when rotating while the optical pickup module 10 is reading.

When the spindle motor 16 is operated at a low rotation speed, as shown in FIG. 6A, the optical disk 18 rotates with little focus vibration. In this case, the S-curve of the FE signal may have a normal S-curve frequency, as shown in FIG. 6B, which enables the focus servo mechanism to perform the S-curve search process easily and ensure focus stability.

However, when the spindle motor 16 is operated at an increased rotation speed, as shown in FIG. 7A, the rotation of optical disk 18 is subject to significantly increased focus vibration. In this case, the S-curve of the FE signal may have a fast S-curve frequency, as shown in FIG. 7B, which is also significantly faster than the normal S-curve frequency in FIG. 6B. This generally leads to a “focus drop” (failure in focusing), in which the FE signal moves beyond the approximate linear portion on the S-curve, as shown in the FE signal diagram of FIG. 2. Consequently, the optical pickup module 10 may retrieve incorrect data.

When focus drop occurs, the FE signal should be reinstated within the range of the approximate linear portion; that is, a re-focusing process should be performed. In this case, the focus servo mechanism is set to begin operation again under open-loop control. However, in the case of the high rotation speed of the spindle motor 16, the fast S-curve frequency of the S-curve increases the difficulty of the S-curve search process. Preferably more bandwidth is allocated to the compensator 32, conforming to the fast S-curve frequency with a certain phase margin while maintaining the high rotation speed of the spindle motor 16, but this is difficult to achieve in practice.

### SUMMARY OF THE INVENTION

In view of this, an object of the present invention is to provide a method of stable focus control for an optical drive in order to overcome the focus inaccuracy due to the significant focus vibration when the optical drive is operated at high rotation speed. The present invention reduces the rotation speed of the spindle motor when significant focus vibration is detected. Thus, significant focus vibration can be reduced, and focus stability is obtained.

The present invention discloses a method of stable focus control for an optical drive having a spindle motor. According to the method, a signal processing circuit is provided for detecting a focus error signal of an optical disk in the optical drive so as to lock a focus point on the optical disk. When the signal processing circuit detects a focus drop, the rotation speed of the spindle motor is reduced, and then the focus servo mechanism performs re-focusing to lock the focus point on the optical disk.

In the method of the present invention, it is preferable to provide a predetermined rotation speed, so that the rotation speed of the spindle motor is reduced when the predetermined rotation speed is exceeded.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing a focus system for the optical pickup module of an optical drive;

FIG. 2 is a diagram showing the focus error (FE) signal and the radio frequency (RF) signal;

FIG. 3 is a block diagram showing a focus servo mechanism under open-loop control;

FIG. 4 is a block diagram showing a focus servo mechanism under closed-loop control;

FIG. 5 is a diagram showing the focusing process of the focus servo mechanism;

FIG. 6A is a schematic view showing the optical disk operated at a low rotation speed;

FIG. 6B is a diagram showing the FE signal of the focus servo mechanism to the optical disk in FIG. 6A;

FIG. 7A is a schematic view showing the optical disk operated at a high rotation speed;

FIG. 7B is a diagram showing the FE signal of the focus servo mechanism to the optical disk in FIG. 7A; and

FIG. 8 is a flow chart showing the method of the present invention, in which re-focusing is performed by braking of the spindle motor.

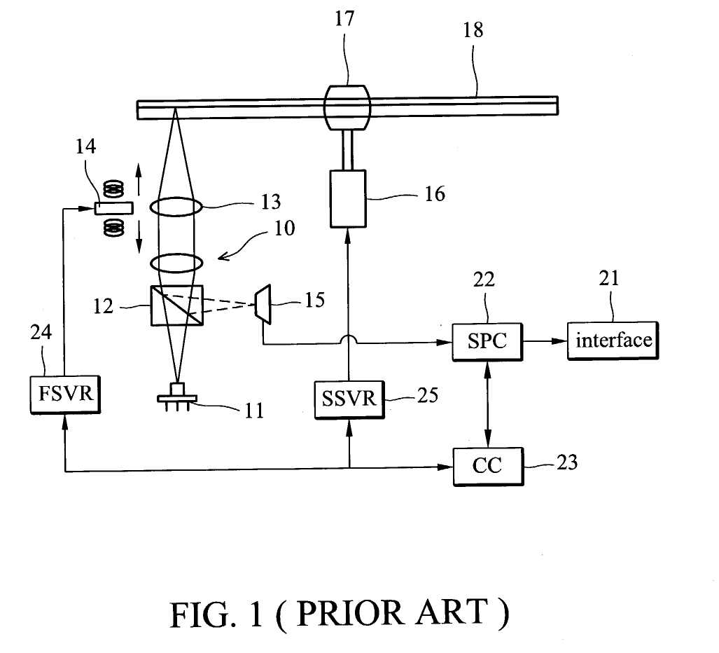

### DETAILED DESCRIPTION OF THE INVENTION

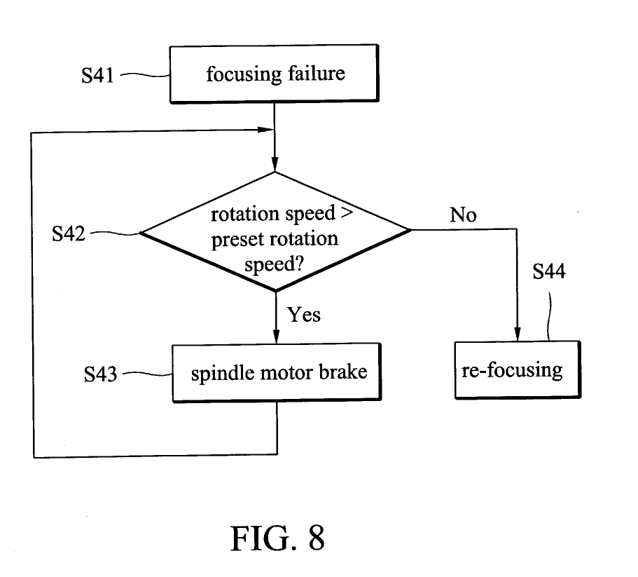

The method of stable focus control for an optical drive of the present invention can be described in detail with reference to the flow chart of FIG. 8.

According to the prior art, the optical disk may be irregularly manufactured or printed in the disk printing process and have a slightly inclined or curved surface, or be placed in an inaccurate position in the disk holding device 17 of the optical drive, so that the disk wobbles when rotating for the optical pickup module 10, which leads to focus vibration. Further, focus vibration increases when the spindle motor 16 of the optical drive is operated with increased rotation speed.

In order to overcome the focus inaccuracy due to the significant focus vibration when the optical drive is operated at high rotation speed, the present invention detects the focus drop, which corresponds to the locking failure of the focus point on the optical disk 18, and reduces the rotation speed of the spindle motor 16 when the focus drop occurs.

In order to detect the focus drop, a signal processing circuit 22 is provided for detecting an FE signal of the optical disk 18 in the optical drive so as to lock the focus point on the surface of the optical disk 18. It is known that when a focus drop occurs (step S41), the FE signal falls beyond the approximate linear portion on the S-curve. In this case, the cause of the focus drop might be focus vibration. Thus, the signal processing circuit 22 of the optical drive detects the rotation speed of the spindle motor 16, and compares the rotation speed of the spindle motor 16 to a predetermined rotation speed (step S42). The predetermined rotation speed corresponds to an acceptable level of the focus vibration. When the rotation speed of the spindle motor 16 is faster than the predetermined rotation speed, the spindle motor 16 brakes (step S43), reducing the rotation speed of the spindle motor 16. When the rotation speed of the spindle motor 16 is slower than the predetermined rotation speed, the reduced focus vibration is acceptable, so that the focus servo mechanism may perform re-focusing (step S44) to lock the focus point on the optical disk 18.

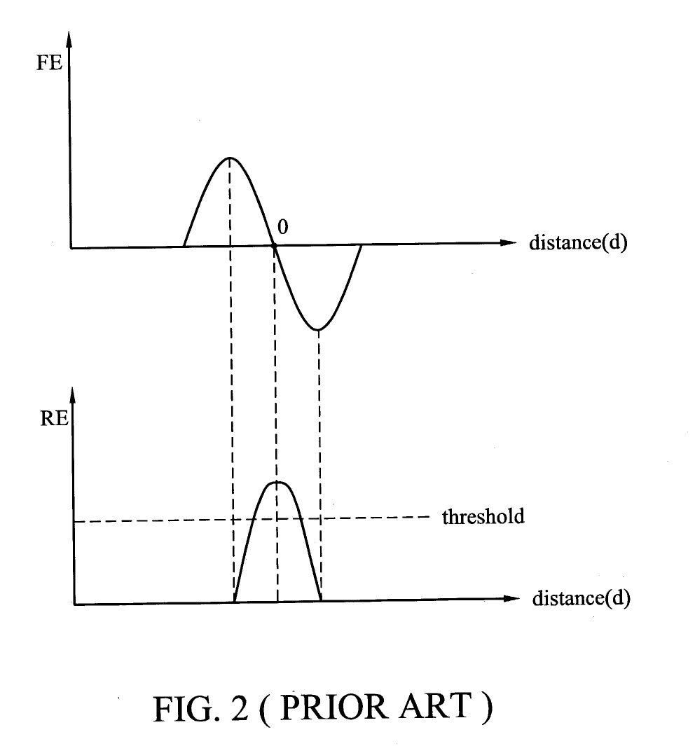

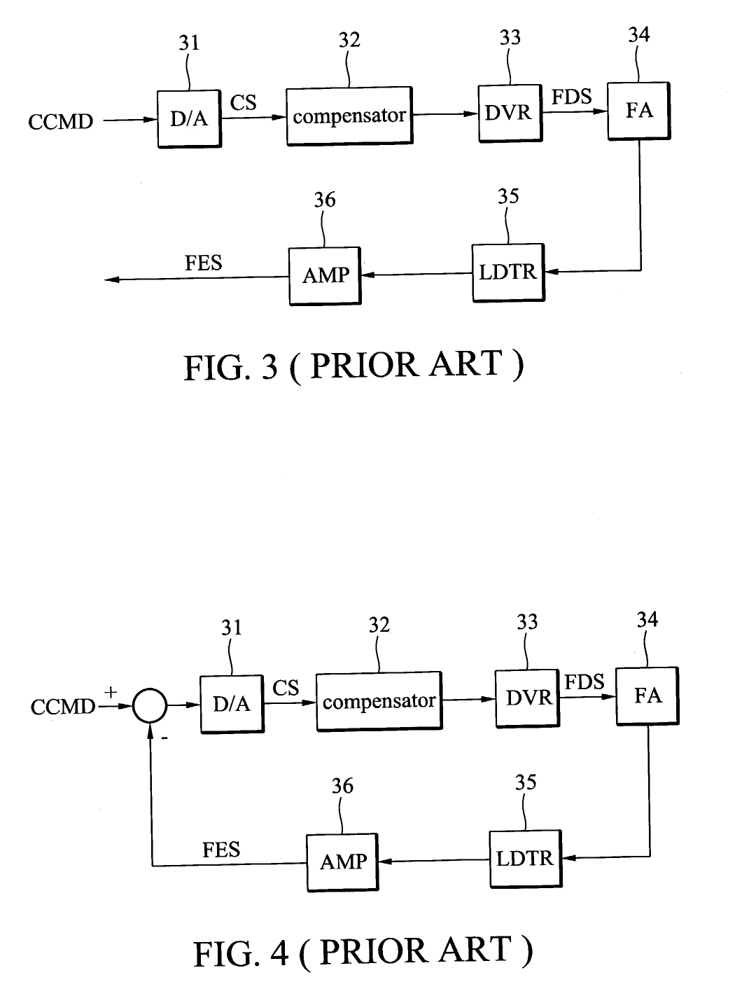

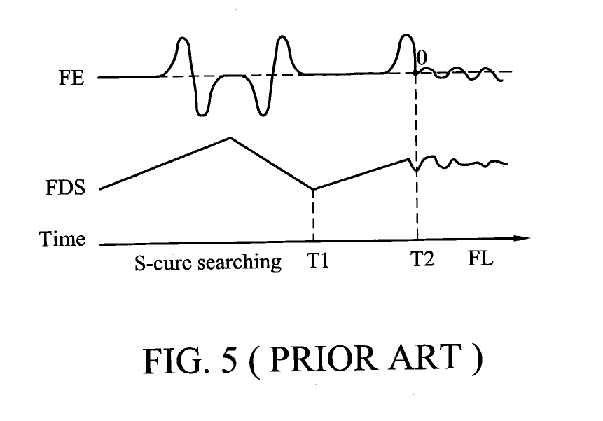

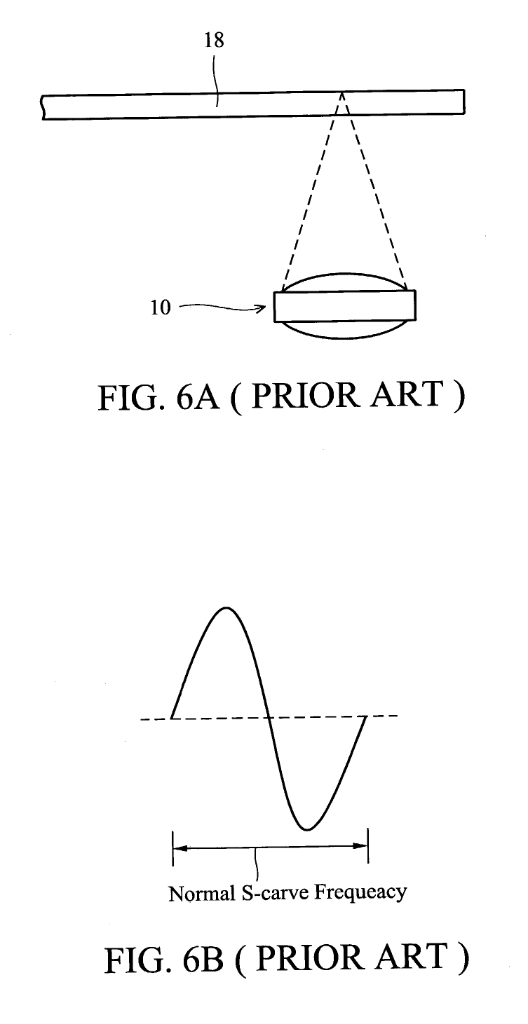

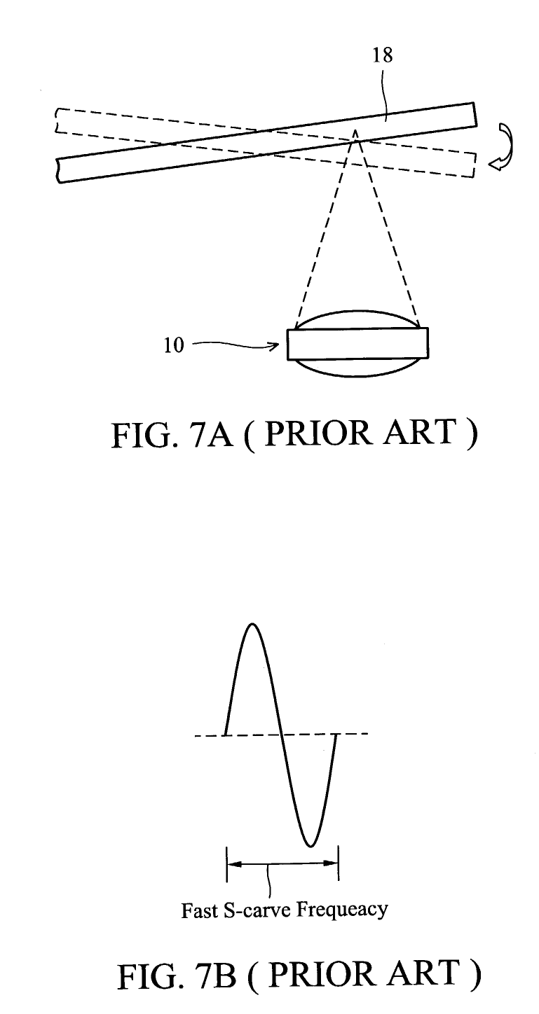

The re-focusing process is similar to the focusing process as described above with reference in FIG. 5. Specifically, the re-focusing process includes the steps of performing the S-curve search process by the focus actuator when the focus servo mechanism is under open-loop control, and resetting the focus servo mechanism to closed-loop control to lock the focus point on the surface of the optical disk 18 when the FZC point O in FIG. 2 is detected by the S-curve search process.

It should be noted that the predetermined rotation speed can be controlled by firmware. It is preferred that the predetermined rotation speed be set by a value giving consideration to both the focus stability and the retrieval speed of the optical drive.

For example, when the optical drive is operated at a high rotation speed, the focus vibration may be significant enough to affect the focus point, so that the FE signal moves beyond the approximate linear portion on the S-curve in FIG. 2. Thus, the spindle motor 16 brakes to reduce the rotation speed of the spindle motor 16 in order to reduce the focus vibration. Further, the rotation speed of the spindle motor 16 is reduced, so the S-curve of the FE signal may have a normal S-curve frequency, which enables the focus servo mechanism to perform the S-curve search process easily. Accordingly, there is no need to broaden the bandwidth of the compensator 32; that is, there is no requirement to re-design or modify the circuit elements of the focus system of the optical drive.

The method of the present invention overcomes focus inaccuracy due to significant focus vibration when the optical drive is operated at high rotation speed. The present invention reduces the rotation speed of the spindle motor when significant focus vibration is detected, whether the focus vibration is due to an irregularly manufactured or printed optical disk or the inaccurate position of the optical disk in the disk holding device of the optical drive. Since significant focus vibration can be reduced by a simple braking of the spindle motor, focus stability can be obtained without any modification of the circuit elements of the focus system of the optical drive.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of stable focus control for an optical drive, the optical drive having a spindle motor, the method comprising the steps of:
providing a signal processing circuit for detecting a focus error signal of an optical disk in the optical drive so as to lock a focus point on the optical disk; and
when the signal processing circuit detects a focus drop, reducing a rotation speed of the spindle motor, and performing re-focusing to lock the focus point on the optical disk.

2. The method of stable focus control for an optical drive according to claim 1, wherein the focus drop corresponds to a locking failure of the focus point on the optical disk.

3. The method of stable focus control for an optical drive according to claim 1, further comprising the steps of:
reducing the rotation speed of the spindle motor when the rotation speed of the spindle motor is faster than a predetermined rotation speed.

4. The method of stable focus control for an optical drive according to claim 3, wherein the predetermined rotation speed is controlled by a firmware.

5. The method of stable focus control for an optical drive according to claim 1, wherein the refocusing step comprises the steps of:
performing an S-curve search process by a focus actuator when the focus servo mechanism is under open-loop control; and
resetting the focus servo mechanism to closed-loop control to lock the focus point on the optical disk when a focus zero-crossing point is detected by the S-curve search process.

6. A method of stable focus control for an optical drive, the optical drive having a spindle motor, the method comprising the steps of:
providing a signal processing circuit for detecting a focus error signal of an optical disk in the optical drive so as to lock a focus point on the optical disk; and
when the signal processing circuit detects a focus drop:
(a) reducing the rotation speed of the spindle motor when the rotation speed of the spindle motor exceeds a predetermined rotation speed;
(b) performing an S-curve search process by a focus actuator when the focus servo mechanism is under open-loop control; and
(c) performing re-focusing by resetting the focus servo mechanism to closed-loop control to lock the focus point on the optical disk when a focus zero-crossing point is detected by the S-curve search process.

7. The method of stable focus control for an optical drive according to claim 6, wherein the focus drop corresponds to a locking failure of the focus point on the optical disk.

8. The method of stable focus control for an optical drive according to claim 6, wherein the predetermined rotation speed is controlled by a firmware.
